(19) United States
(12) Patent Application Publication
(10) Pub. No.: US 2009/0277812 A1
(43) Pub. Date: Nov. 12, 2009

(54) Stackable Drinking Vessels And Methods Of Use And Manufacture Thereof

(76) Inventor: Daniel G. Driscoll, Atlanta, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 12/117,422

(22) Filed: May 8, 2008

Related U.S. Application Data
(60) Provisional application No. 61/051,481, filed on May 8, 2008.

(51) Int. Cl. B65D 21/00; A47J 41/00; B65D 25/10; A47G 19/22

(52) U.S. Cl. 206/499; 206/515; 220/592.2; 220/710.5; 220/703

(57) ABSTRACT

A nesting, wide-bottom drinking vessel is disclosed that provides for convenient and efficient stacked storage thereof that is stable during use. The vessel may include one or more handles or other gripping structure operable to allow a user to conveniently grasp the vessel without interfering with nesting engagement during storage.

### RELATED APPLICATION

The present United States non-provisional patent application is related to, and hereby claims priority to, and the full benefit of, United States provisional patent application entitled “Stackable Drinking Vessels and Methods of Use and Manufacture Thereof” filed May 8, 2008 on behalf of Daniel G. Driscoll, having assigned Ser. No. 61/051,481, incorporated herein by reference.

### TECHNICAL FIELD

The present disclosure relates generally to drinking vessels, and, more particularly, to stackable, nesting drinking vessels.

### BACKGROUND OF THE INVENTION

In numerous beverage service situations, such as in some restaurants, at sporting events, aboard transportation vehicles, among other situations, disposable beverage containers are preferred. As a result, numerous disposable beverage containers in the form of nesting cups have been developed and implemented. In order for such cups to nest, and thus be conducive to efficient storage, the cups include a top that is wider than a base thereof. Accordingly, such cups suffer from easily being inadvertently tipped or knocked over, and spilling any contents. This design flaw is particularly disadvantageous when such cups are used for hot beverage service. Where hot beverages are involved, spills caused by tipping or knocking over a cup, or even simply bumping or jostling a cup, can cause serious injury.

Additionally, cups designed for use with hot beverages typically involve materials and/or structural features that are complex, expensive, flimsy, un-insulated, and/or environmentally damaging. For example, polystyrene foam cups, corrugated cardboard sleeves, and paper cups with polyethylene coatings provide thermal insulation due to trapped air pockets, but each of these solutions also involves higher cost and/or adverse impact on the environment due to lengthy landfill residence time.

Thus, it is clear that there is an unmet need for a stackable, nesting vessel that is stable and resists spills and/or tipping during use, and for a stackable, nesting drinking vessel that provides insulation for hot or cold beverages that is simple and inexpensive to manufacture and that is recyclable.

### BRIEF SUMMARY OF THE INVENTION

Briefly described, in a preferred embodiment, the nesting drinking vessel of the present disclosure overcomes the above-mentioned disadvantages and meets the recognized need for such a vessel by providing a stackable, nesting, wide-bottom cup.

More specifically, and in one embodiment, the cup includes a plurality of pleats, folds, or the like, operable to reduce a cross-sectional dimension of a top of the cup. The cup may be stored in a first configuration, wherein the cross-sectional dimension of the top is greater than a cross-sectional dimension of a bottom of the cup. Thus, in the first configuration, the cup may preferably be stored in a stacked, nested arrangement with at least one other cup. The cup may be disposed in a second configuration for use, wherein the cross-sectional dimension of the top is reduced, such as via folding. A rim of the cup preferably includes means for securing the cup in the folded second configuration, such as interlocking and/or overlapping rim sections, or otherwise mutually-engaging adjacent sections of the cup. The cup optionally includes a handle portion providing a thermally-insulated or thermally-isolated gripping portion, particularly for use with hot beverages or iced beverages. The handle portion is preferably formed by the process used to convert the cup from the first storage configuration to the second use configuration, such as wherein the handle portion comprises a section of a blank from which the cup is formed by folding.

Accordingly, one feature and advantage of the cup is its ability to be efficiently stored in a stacked arrangement, and to provide a stable cup having a wide bottom relative to the top during use.

Another feature and advantage of the cup is its ability to provide a simple and inexpensive cup having a handle for use with hot or cold beverages.

In another preferred embodiment, the vessel of the present disclosure provides an insulated, stackable, nesting vessel having a base that is wider than a top thereof, whereby the vessel is stable in use. The vessel may additionally include one or more handles, including but not limited to hinged or flexible handle(s). The vessel preferably includes a space between an exterior sidewall and an interior sidewall, thereby insulating the exterior sidewall from the contents of the vessel. The vessel may further optionally include a top lid to prevent spillage of the contents. Similarly, a bottom lid may be provided to allow ice or other substance to be enclosed proximate the interior sidewall, whereby the contents may be cooled, or warmed, as desired.

Accordingly, a feature and advantage of the vessel is its ability to allow convenient and efficient stacked, nesting storage and to provide a stable vessel during use that resists tipping and/or spills.

Another feature and advantage of the vessel is its ability to provide an inexpensive and recyclable nesting container for hot or cold beverages.

These and other features and advantages of the present invention will become more apparent to those ordinarily skilled in the art after reading the following Detailed Description of the Invention and Claims in light of the accompanying drawing Figures.

### BRIEF DESCRIPTION OF THE DRAWINGS

Accordingly, the present invention will be understood best through consideration of, and with reference to, the following drawings, viewed in conjunction with the Detailed Description of the Invention referring thereto, in which like reference numbers throughout the various drawings designate like structure, and in which:

FIG. 1 is a perspective view of a container in a storage configuration;

FIG. 2 is a detail view of fastening means of the container of FIG. 1;

FIG. 3 is a perspective view of the container of FIG. 1 in a transition configuration between the storage configuration and a use configuration;

FIG. 4 is a perspective view of the container of FIG. 1 in the use configuration;

FIG. 5 is a top view of the container of FIG. 4;

FIG. 6A is a front view of the container of FIG. 4;

FIG. 6B is a front view of an alternate embodiment of the container of FIG. 6A;

FIG. 7 is a bottom view of the container of FIG. 4;

FIG. 8 is a detail view of alternate fastening means of the container of FIG. 1;

FIG. 9 is a detail view of an interior surface of the container of FIG. 4 according to an alternate embodiment;

FIG. 10 is a front perspective view of the container of FIG. 4 according to an alternate embodiment;

FIG. 11 is a bottom perspective view of the container of FIG. 4 according to an alternate embodiment;

FIG. 12 is a detail view of another alternate fastening means of the container of FIG. 1;

FIG. 13A is a detail view of yet another alternate fastening means of the container of FIG. 1 in the storage configuration;

FIG. 13B is a detail view of the fastening means of FIG. 13A in the use configuration;

FIG. 14 is top perspective view of a container according to an alternate embodiment;

FIG. 15A is a side perspective view of the container of FIG. 14;

FIG. 15B is a side perspective view of the container of FIG. 13 according to an alternate embodiment;

FIG. 16A is side view of the container of FIG. 14;

FIG. 16B is a detail side view of the container of FIG. 14 according to another alternate embodiment;

FIG. 17 is a bottom view of the container of FIG. 14;

FIG. 18 is a top view of the container of FIG. 14;

FIG. 19 is a side cross-sectional view of the container of FIG. 13 stacked with another container in a storage configuration;

FIG. 20 is a side cross-sectional view of the container of FIG. 13 in a use configuration;

FIG. 21 is a side cross-sectional view of the container according to an alternate configuration;

FIG. 22A is a front perspective view of the container according to another alternate configuration;

FIG. 22B is a front perspective view of the container of FIG. 22A according to another alternate configuration;

FIG. 23 is a front view of the container of FIG. 22A;

FIG. 24 is a back view of the container of FIG. 22A;

FIG. 25 is a left side view of the container of FIG. 22A;

FIG. 26 is a right side view of the container of FIG. 22A;

FIG. 27 is a top view of the container of FIG. 22A;

FIG. 28 is a bottom view of the container of FIG. 22A;

FIG. 29 is a side cross-sectional view of the container of FIG. 14 according to another alternate configuration;

FIG. 30 is a side cross-sectional view of the container of FIG. 14 according to another configuration;

FIG. 31 is a front perspective view of a container according to another alternate configuration;

FIG. 32 is a top view of the container of FIG. 31;

FIG. 33 is a side cross-sectional view of the container of FIG. 31 in a use configuration;

FIG. 34 is a side cross-sectional view of the container of FIG. 31 in a storage configuration;

FIG. 35 is a detail view of the container of FIG. 31 according to an alternate configuration;

FIG. 36 is a perspective view of the container of FIG. 31 according to another alternate configuration;

FIG. 37A is a perspective view of the container of FIG. 36;

FIG. 37B is a detail view of an alternate embodiment of the container of FIG. 37A.

FIG. 38 is bottom view of the container of FIG. 36;

FIG. 39 is top view of the container of FIG. 36; and

FIG. 40 is a perspective view of a nested stack of containers.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing various embodiments of the vessel of the present disclosure illustrated in the drawings, specific terminology is employed for the sake of clarity. The claimed invention, however, is not intended to be limited to the specific terminology so selected, and it is to be understood that each specific element includes all technical equivalents that operate in a similar manner to accomplish a similar purpose.

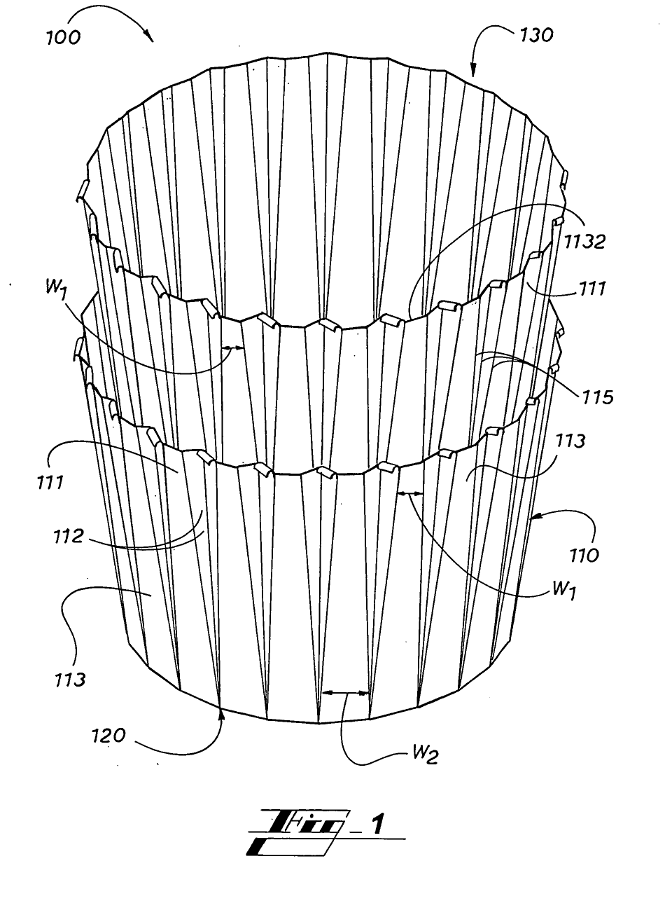

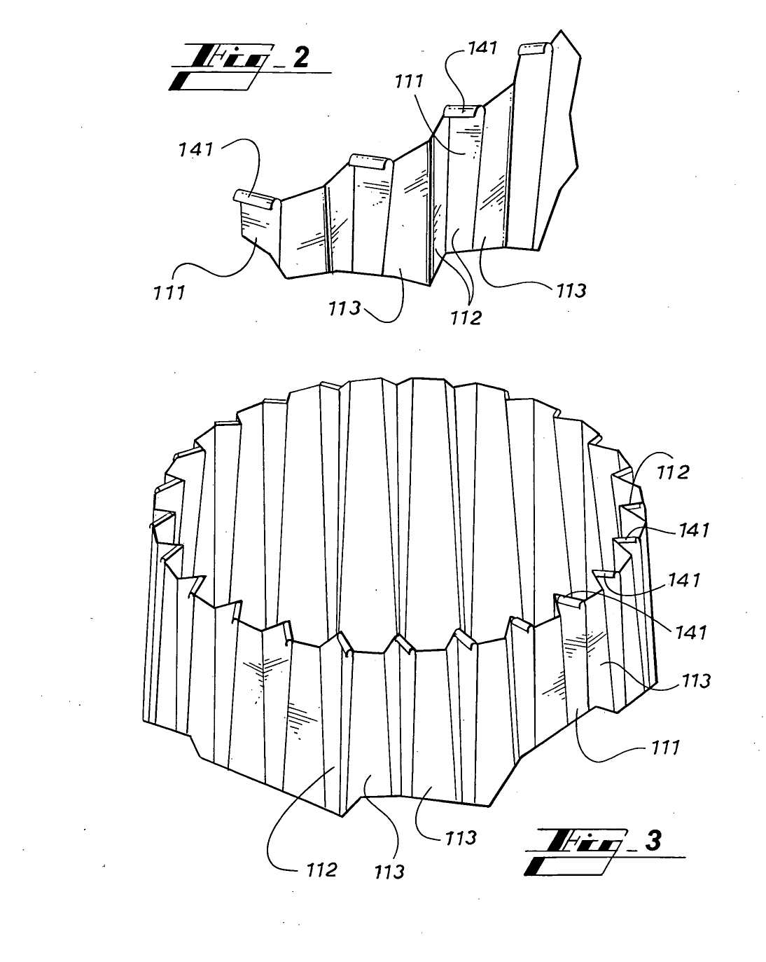

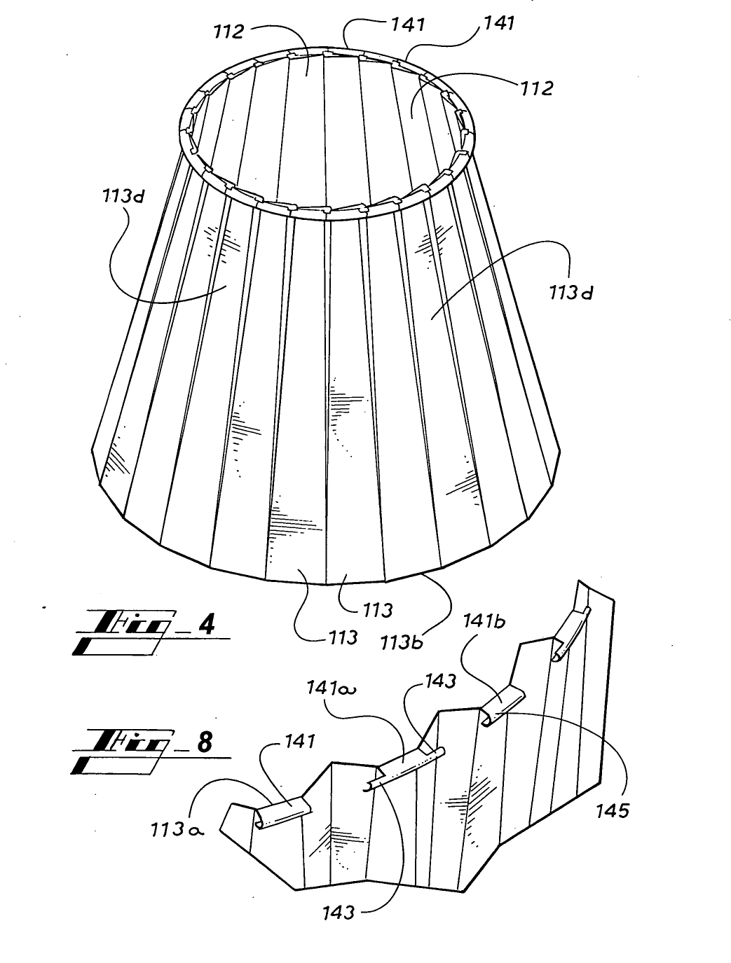

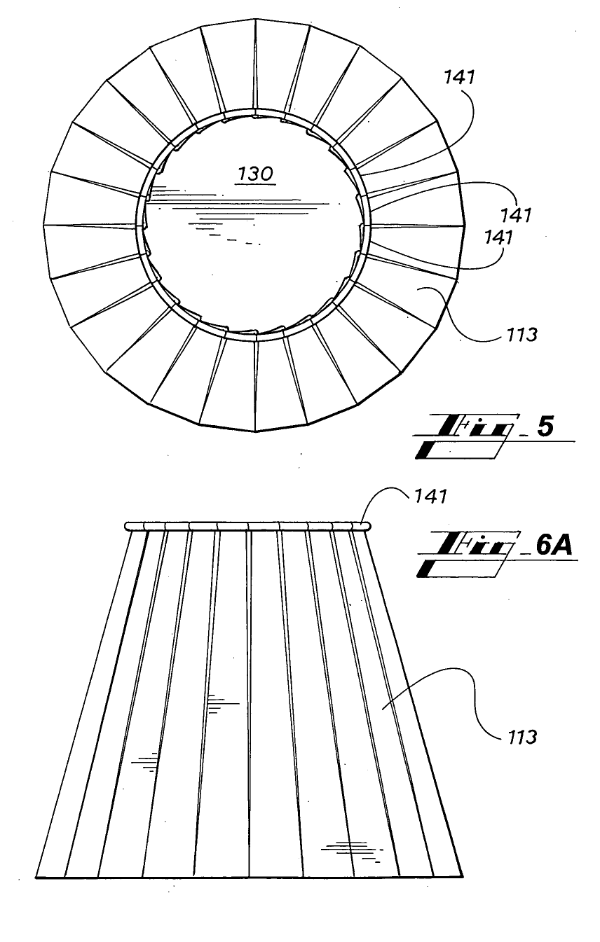

An exemplary embodiment of a stackable wide-bottom vessel formed as a cup is illustrated in FIGS. 1-7, and includes body 100 formed as a substantially thin sheet of material, such as a paper material, a plastic material, or the like, having expandable sidewall 110 and bottom 120. Expandable sidewall 110 preferably defines open top 130. Expandable sidewall 110 may further include a plurality of pleated or folded areas 111 and a plurality of generally planar areas 113 therebetween, whereby a dimension of at least a portion of expandable sidewall 110 may be adjusted. Sidewall 110 and bottom 120 may be integrally formed from a unitary sheet, or may be formed separately and joined, such as by adhesive, welding, or the like.

Specifically, each generally planar area 113 is preferably formed as a generally trapezoidal area of adjustable sidewall 110 having a first width W₁ proximate top edge 113a thereof, and a second, greater width W₂ proximate bottom edge 113b thereof. Each pleated or folded area 111 is preferably formed as two or more generally triangular areas 112. As will be understood by those ordinarily skilled in the art, triangular areas 112 may be formed by selectively folding expandable sidewall 110 along fold lines 115, or the like.

In a first storage configuration, illustrated in FIG. 1, top 130 of body 100 has a greater cross-sectional dimension than bottom 120. That is to say, that a width of top 130 as measured in an axial cross section, a cross-sectional area of top 130 as measured in a radial cross section, or the like, is greater than a corresponding dimension of bottom 120. Accordingly, body 100 is stackable in the first storage configuration by inserting bottom 120 of a first body 100 into the open top 130 of another body 100, i.e. by nesting two bodies 100. In a second use configuration, illustrated in FIGS. 4, 5, and 6, top 130 of body 100 has a smaller cross-sectional dimension than bottom 120. Thus, a center of gravity of body 100 and liquid contents stored therein is closer to bottom 120 in the second use configuration. Accordingly, body 100 is more stable and more difficult to tip or knock over in the second use configuration, but may nonetheless be stacked in a nested arrangement in the first storage configuration.

In the exemplary embodiment of FIGS. 1-7, and as best illustrated in FIG. 2, a top edge 111a of a plurality of folded areas 111 preferably includes a rim section 141 formed as a arcuate or rounded portion. Preferably, each rim section 141 is formed in approximately the same shape as a conventional rolled rim. Furthermore, each rim section 141 preferably comprises a resilient material capable of deformation and elastic return to the original rolled shape. Thus, in use, when areas 111 are folded to bring adjacent planar area 113 into generally abutting relationship (as shown e.g. in FIG. 6), rim section 141 of an innermost folded area 111 preferably extends over an intermediate folded area 111 and a planar area 113, thereby engaging and retaining the two folded areas 111 and the planar area 113 in the folded configuration (i.e. thereby retaining body 100 in the second use configuration).

As will be understood by those ordinarily skilled in the art, each folded area 110 and each planar area 113 may optionally include a rim section 141, such as for ease of manufacturing, for improved retention of folded areas 111, or the like. It should be noted that if a rim section 141 is included on both triangular areas 112 in the embodiment of FIG. 2, then the rim sections should be oriented in opposing directions. That is to say, a first rim section 141 should extend outwardly while a second rim section 141 should extend inwardly, such that when the folding process is completed, each rim section 141 will extend outwardly and will be situated generally in registration with the other rim sections 141.

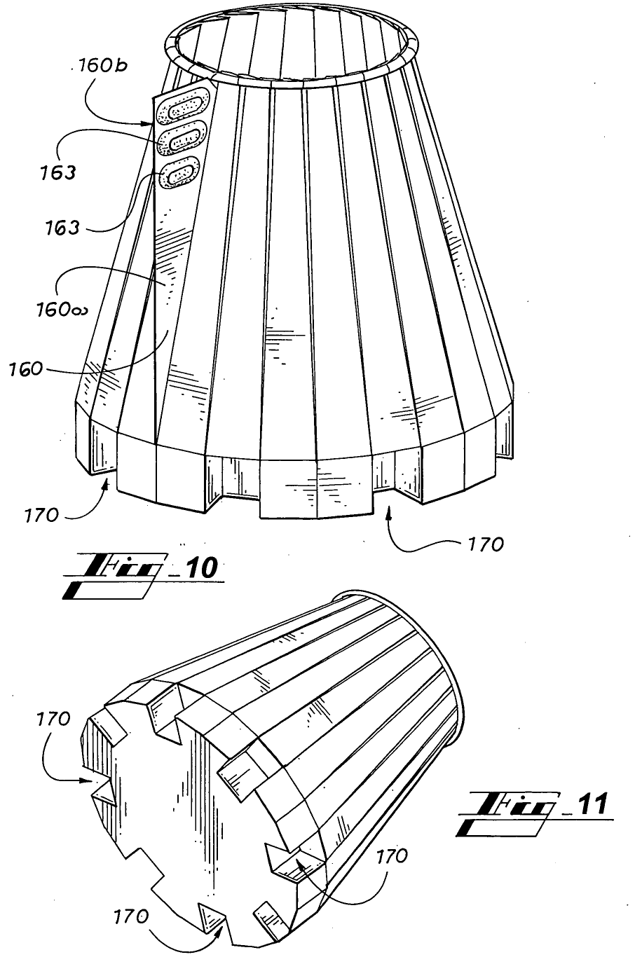

As will further be understood by those ordinarily skilled in the art, such flat folding of folded areas 111 may be facilitated by selective creasing, relief cuts along folds 115, or the like. Furthermore, and as discussed further with reference to FIGS. 13A and 13B, to facilitate such flat folding of folded areas 111, a first one of a pair of folded area 111 may be formed having a larger top edge 111a than the second folded area 111, whereby alignment of generally abutting edges of adjacent planar areas 113 is possible only when folded areas 111 generally lay flat against a planar area 113 with the first one of the pair of folded areas 111 disposed inward of the second folded area 111.

Optionally, and referring particularly to FIG. 6B, a coefficient of friction of an exterior surface of body 100 may be increased to facilitate gripping by a user. For example, one or more exterior surface(s) 113d, or at least a portion thereof, may include an adhesive material, a high-friction coating, a high friction texture such as ribs or ridges 113e, or the like, to enable secure gripping. Preferably, however, inclusion of such a high friction material or texture does not affect an ability to recycle body 100 after use. For example, inclusion of a plastic textured membrane, film, or coating on each exterior surface 113d should be avoided when body 100 is formed from paper. Accordingly, ribs or ridges 113e are preferred.

Now referring to FIG. 8, in an alternative embodiment, a top edge 113a of each generally planar area 113 may include a respective rim section 141. Body 100 may be formed to include rim sections 141 of first type 141a and second type 141b disposed in an alternating pattern on adjacent ones of generally planar areas 113. Rim sections 141 of first type 141a preferably include a projection or male fitting 143 extending therefrom generally in a direction towards an adjacent rim section 141 of an adjacent generally planar area 113. Rim sections 141 of second type 141b preferably include a channel or female fitting configured and arranged to receive or engage a corresponding adjacent projection or male fitting 143.

Accordingly, when disposed in the second use configuration, i.e. when expandable side wall 110 is compressed, each projection or male fitting 143 preferably extends into and engages an adjacent channel or female fitting 145. Each projection or male fitting 143 may be retained in engagement with a respective channel or female fitting 145 by friction, by mechanical retention means such as barbs, by adhesive, or the like. As will be understood by those ordinarily skilled in the art, when a projection or male fitting 143 is engaged with an adjacent channel or female fitting 145, adjacent side edge portions of respective generally planar areas 113 are preferably disposed in abutting contact, wherein such relative movement between adjacent generally planar areas 113 is enabled via operation of a pleated or folded area 111 therebetween. Thus, in the second use configuration, an exposed exterior surface of expandable sidewall 110 includes only generally planar areas 113, wherein each pleated or folded area 111 is disposed projecting inwardly into an interior space of body 100.

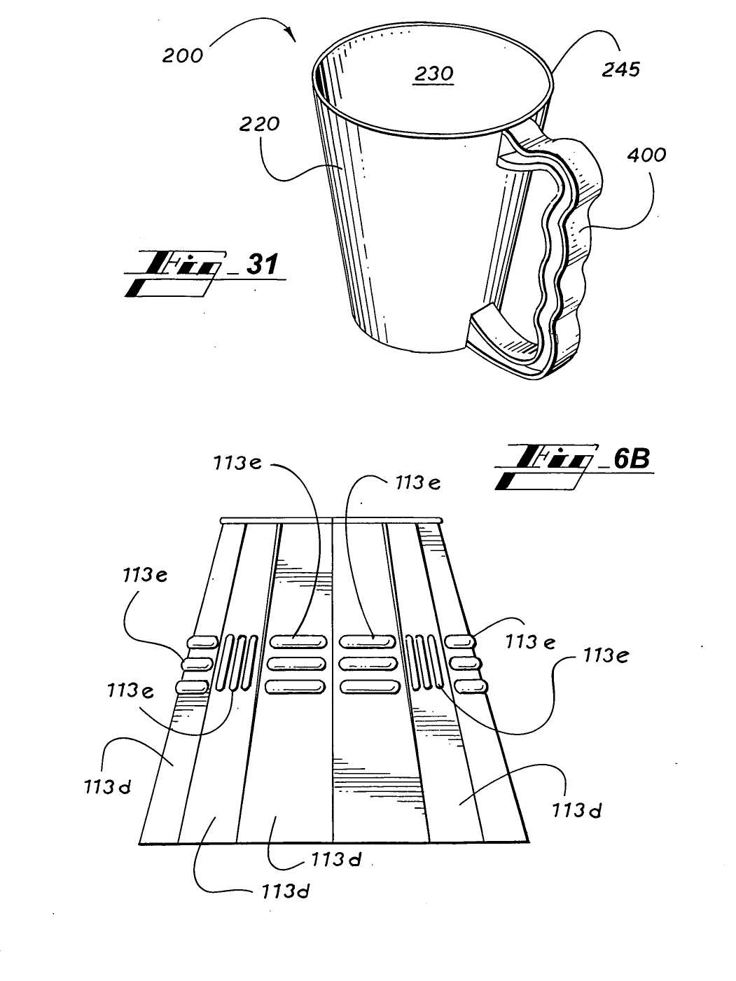

Now referring to FIG. 9, a flange 151 or the like may be included on a respective interior surface 113c of one or more generally planar area 113 when folded areas 111 are not designed to generally lay flat, such as in the embodiment of FIG. 8. Flange 151 preferably comprises a piece of material substantially similar to the material used for body 100, and is preferably disposed extending generally perpendicular to generally planar area 113. As illustrated, each flange 151 preferably forms a barrier substantially preventing liquid flow within a channel 153 formed between adjacent ones of pleated or folded areas 111. Each flange 151 preferably acts to substantially prevent liquid contents of body 100 from becoming trapped within a respective channel 153 during use in drinking. Furthermore, each flange 151 preferably acts as a baffle or dam to deflect liquid to prevent liquid contents of body 110 from spilling, such as may otherwise occur from sloshing, or the like.

Optionally, body 100 may further include handle 160 to allow a user to easily and securely grip body 100. As illustrated in FIG. 10, handle 160 is formed by fold or crease 161 in a portion of a pleated or folded area 111 extending generally perpendicularly from expandable sidewall 110. Accordingly, handle 160 is preferably formed from two adjacent plies of material, such as first ply 160a and second ply 160b. As will be understood by those ordinarily skilled in the art, handle 160 may be formed having any desired shape or size, and is preferably arranged at least proximate top 130. Additionally, handle 160 may include one or more ridge(s) 163 or other surface structure(s) or projection(s). Ridge 163 is preferably formed in first ply 160a and second ply 160b such that ridge 163 of second ply 160b may engage and be retained within ridge 163 of first ply 160a, such as by frictional engagement. Thus, first ply 160a and 160b may preferably be secured together by ridge 163, thereby substantially preventing separation or unfolding thereof.

Furthermore, and as illustrated in FIGS. 10 and 11, body 100 may optionally be formed including one or more indentation(s) 170, or the like. Preferably, eight indentations 170 are included at equal intervals around body 100 proximate bottom 120. Indentations 170 may preferably be used for gripping by a user, whereby secure holding and/or lifting of body 100 may be enabled, even without high friction material or texture included on exterior surfaces 113d. Furthermore, indentations 170 may be used in conjunction with, or in place of, handle 160 and/or ribs or ridges 113e.

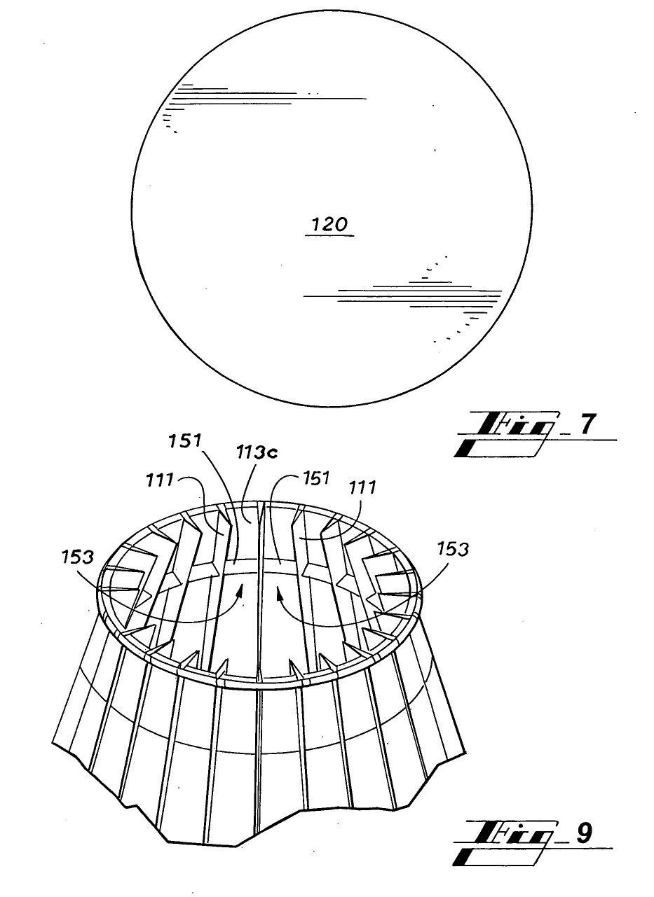

Although pleated or folded areas 111 have been described and illustrated with two generally triangular areas 112, four or more triangular areas 112 may be included, as illustrated in FIG. 12. As will be understood by those ordinarily skilled in the art, increasing the number of triangular areas 112 between adjacent generally planar areas 113 may preferably increase a change in cross-sectional area associated with folding each pleated or folded area 111 and/or reduce a distance that generally triangular areas 112 project into an interior cavity of body 100.

Now referring to FIG. 13, each pleated or folded area 111 may preferably be disposed in a position substantially parallel with and/or abutting an adjacent planar area 113, as in the embodiment of FIGS. 1-7. In such an arrangement, pleated or folded areas 111 preferably do not interfere with a user's mouth during drinking, and preferably do not create channels 153 therebetween. In order to retain first triangular area 181 and second triangular area 182 of pleated or folded area 111 in such a flat configuration, first triangular area 181 may have a length along top edge 111a less than a length along top edge 111a of second triangular area 182. Alternatively, at least a portion of first triangular area 181 or second triangular area 182 may engage a rim section 141 adjacent the other one of first triangular area 181 and second triangular area 182 whereby first triangular area 181 and second triangular area 182 lay substantially flat against an adjacent planar area 113.

With continued reference to FIG. 13, third type 141c of rim section 141 is shown having protrusion or male fitting 143 disposed on a first end and channel or female fitting 145 formed on a second end. As will be understood by those ordinarily skilled in the art, first type 141a and second type 141b of rim section 141 may, alternatively, each be replaced with third type 141c of rim section 141 to perform the function described above.

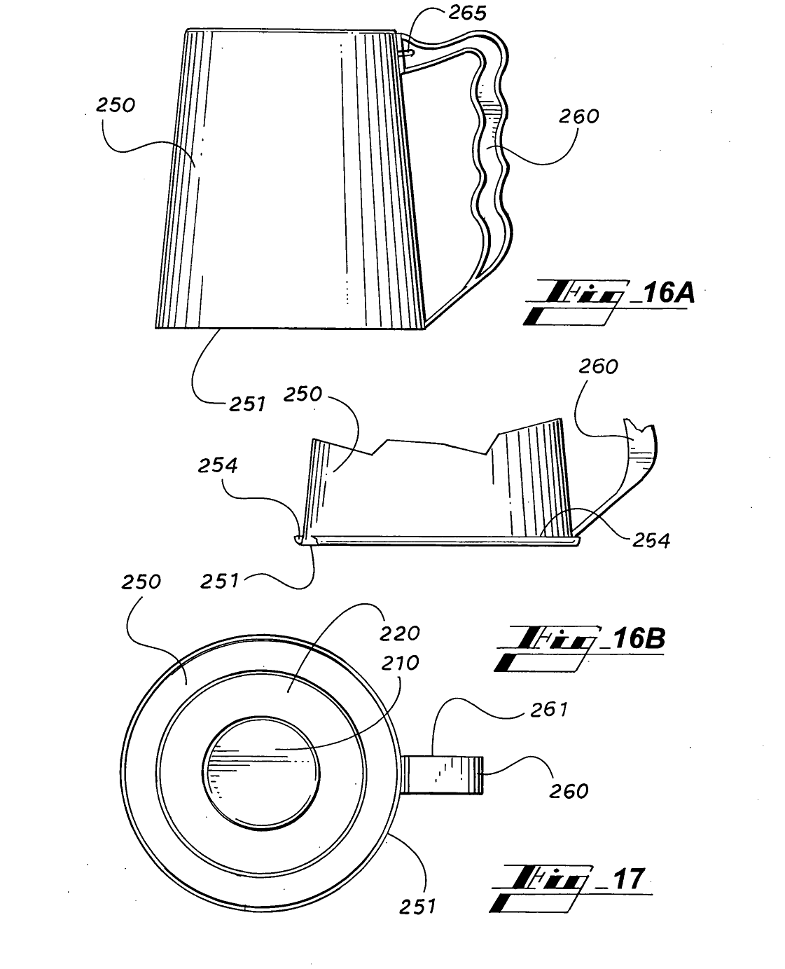

Now referring to FIGS. 14-20, a drinking vessel formed as a nesting wide-bottom mug 200 preferably includes body 201 formed from a generally thin material, such as paper, plastic, silicone, composite, combinations thereof, or the like. Body 201 preferably includes bottom 210 and first, inner frusto-conical sidewall 220 defining partially-enclosed space 230 and open top 240, and further includes second, outer frusto-conical sidewall 250 and handle 260. Inner frusto-conical sidewall 220 is preferably arranged such that a cross-sectional dimension (such as a diameter or circumference) increases with distance from bottom 210. Inner frusto-conical sidewall 220 and outer frusto-conical sidewall 250 preferably meet proximate respective upper peripheral edges thereof defining rim 245. Outer frusto-conical sidewall 250 is preferably arranged such that a cross-sectional dimension (such as a diameter or circumference) increases with distance from rim 245. Thus, bottom edge 251 of outer sidewall 250 preferably has a greater cross-sectional dimension than does rim 245. Accordingly, mug 200 resists tipping and provides a stable base.

As will be understood by those ordinarily skilled in the art, bottom 210, inner frusto-conical sidewall 220, outer frusto-conical sidewall 250, and/or handle 260 may be integrally formed from a single piece of material, or one or more of such components may be formed separately and connected via adhesive, welding, or the like. Regardless of construction, however, a seam, joint, transition, or the like between bottom 210 and inner frusto-conical sidewall 220 is preferably water-proof, whereby liquid may be contained within partially enclosed space 230. Likewise, a seam, joint, or transition between inner frusto-conical sidewall 220 and outer frusto-conical sidewall 250 preferably prevents liquid from penetrating therethrough, whereby liquid may not leak between inner and outer sidewalls 220 and 250 during drinking, and whereby any contents stored therebetween (discussed in greater detail below) may not escape during drinking.

Handle 260 is preferably hingedly operable with outer frusto-conical sidewall 250 at a first portion of handle 260. For example, first end 261 of handle 260 may be hingedly connected to bottom edge 251 of outer frusto-conical sidewall 250. Furthermore, handle 260 is preferably releasably selectively operable with outer frusto-conical sidewall 250 at a second portion of handle 260. For example, second end 263 of handle 260 may be removably or releasably operable with an upper portion of outer sidewall 250 proximate rim 245. As will be understood by those ordinarily skilled in the art, the movement of second end 263 of handle 260 enabled by hinged first end 261 may alternatively be provided by a resiliency and/or flexibility of handle 260 or at least a portion thereof, so long as handle 260 is movable between a first storage position where second end is spaced from rim 245 sufficiently to allow nesting with additional mugs 200 and a second use position where second end 263 is engaged with outer sidewall 250.

More specifically, and as best seen in FIG. 19, second end 263 of handle 260 preferably includes an attachment structure, such as prongs 267 adapted to engage aperture 253 formed in outer sidewall 250 proximate rim 245. Prongs 267 are preferably releasable from engagement with outer sidewall 250 by compression of second end 263 of handle 260 and/or by resilience or flexibility of prongs 267. Such compression of second end 263 of handle 260 may be enabled by notch 265 formed therein. Additionally, or alternatively, second end 263 of handle 260 may include a permanent or releasable adhesive material disposed on end face 269 for securing second end 263 to outer sidewall 250, thereby substantially preventing separation of second end 263 from outer sidewall 250.

Accordingly, nesting wide-bottom mug 200 may be manufactured, stored, and distributed in a first storage configuration in which second end 263 of handle 260 is not engaged with outer sidewall 250, whereby handle 260 may not substantially interfere with nesting of a plurality of mugs 200. When use is desired, mug 200 may be placed in a second use configuration, illustrated in FIG. 20 among others, by securely engaging second end 263 of handle 260 with outer sidewall 250, whereafter a user may lift and hold mug 200 via handle 260. Thus, handle 260 preferably provides a convenient gripping structure that is substantially thermally-insulated from a liquid contained within mug 200. Accordingly, mug 200 may beneficially be used for service of hot or cold beverages without the need for separate sleeves, expensive and/or environmentally damaging materials, or the like.

As further illustrated in FIG. 20, top lid 301 and/or bottom lid 305 may be included to at least partially seal open top 240 and/or bottom opening 270, respectively. As will be understood by those ordinarily skilled in the art, top lid 301 may be removably operable with rim 245 and may optionally include a mouth or spout for allowing liquid to pass therethrough and/or a vent hole. Lid 301 may selectively be engaged with rim 245 to prevent liquid from spilling from mug 200, and is beneficial in preventing burns when used with hot beverages. Similarly, bottom lid 305 may be removable operable with bottom edge 251 of outer sidewall 250 to enclose space 310 between inner sidewall 220 and outer sidewall 250. Bottom lid 305 may be used to provide a solid bottom for mug 200, to increase rigidity of outer sidewall 250, and/or to retain ice or the like within space 310 for cooling liquid contents of mug 200 without diluting same. In order for lid 301 and/or 305 to be easily engaged with mug 200, open top 240 and bottom opening 270 are formed as circular openings, whereby orientation of lid 301 and/or 305 may not impact an ability to engage a respective one of open top 240 and bottom opening 270.

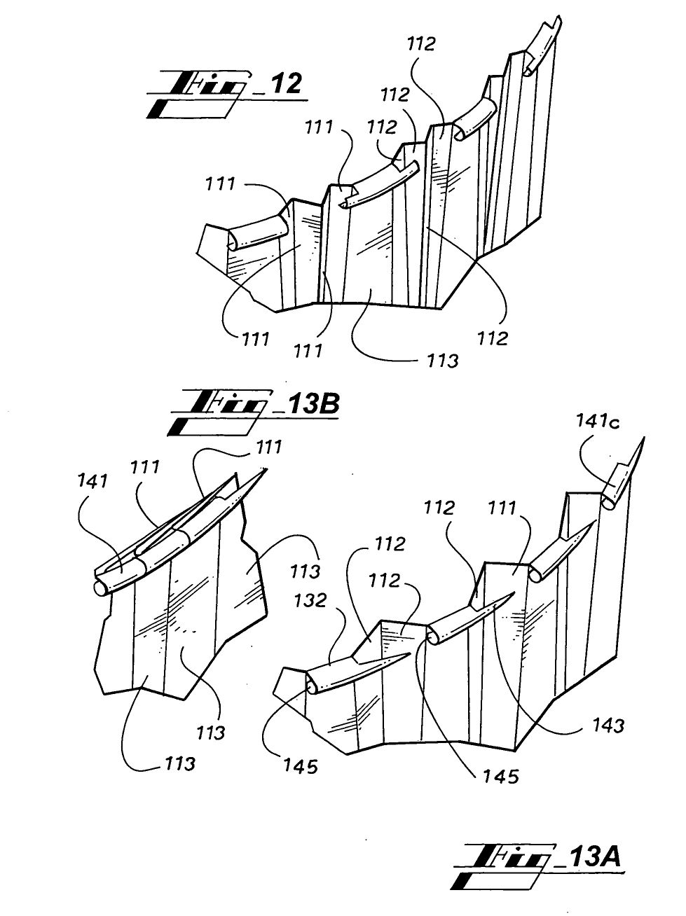

Referring specifically to FIG. 15B, outer sidewall 250 may optionally include ribs or ridges 257 thereon. Such ribs or ridges 257 preferably provide a textured surface over at least a portion of outer sidewall 250, whereby gripping sidewall 250 may be enabled despite a tapering thereof. Ribs or ridges 257 may be arranged generally vertically, generally horizontally, at other angles, forming a grid pattern, or the like as desired.

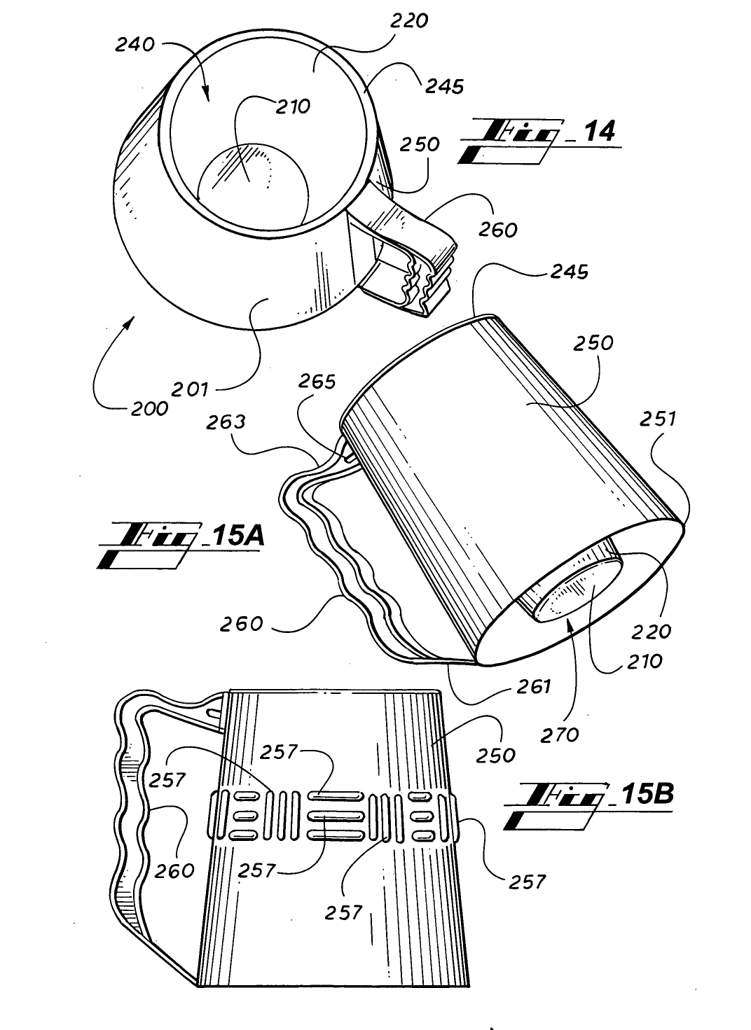

As another option, and as illustrated in FIG. 16B, bottom edge 251 of sidewall 250 may include gutter 254 formed thereon and comprising a channel in which drips may accumulate. Accordingly, a liquid, such as a beverage or condensed water, may drip or run down sidewall 250 and be trapped within gutter 254. Thus, rings, spills, or other stains or marks associated with liquid spilling from mug 200 or condensing thereon may be avoided. As will be understood by those ordinarily skilled in the art, gutter 254 may be formed on a medial section of sidewall 250, in addition to or in place of gutter 254 formed on bottom edge 251, if desired.

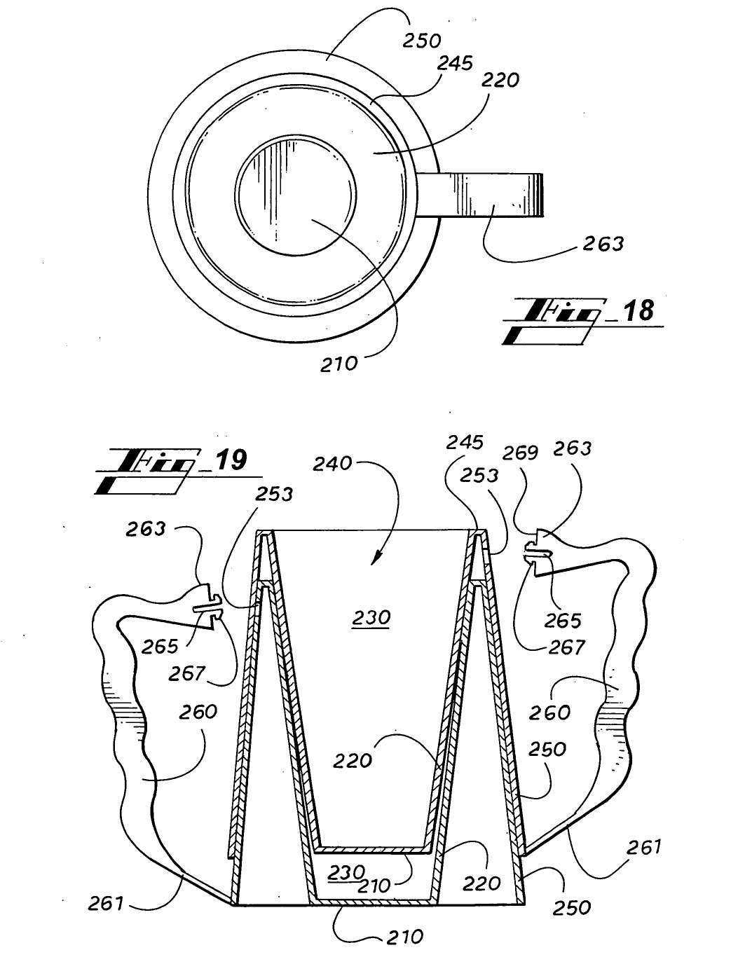

Now referring to FIG. 21, outer sidewall 250 may optionally include depression or channel 255 formed over at least a portion thereof for facilitating gripping by a user. For example, depression or channel 255 may be formed as an equatorial or medial waist or local region of smallest cross-sectional dimension extending completely around mug 200. Alternatively, depression or channel 255 may be formed as one or more divots, dimples, or the like, adapted to receive a user's finger tip. The curvature of depression or channel 255 preferably increases a frictional engagement force with a user's hand or fingers to make grasping mug 200 more secure. Depression or channel 255 may be used in conjunction with or in place of handle 260. It should be noted, however, that inclusion of depression or channel 255 will impact an ability to nest mugs 200. Specifically, a deeper depression or channel 255 included in outer sidewall 250 will result in a greater incremental increase in height of a stack of nested mugs 200 associated with the addition of another mug 200. Thus, if included, depression or channel 255 is preferably generally shallow, such that the tension between the interest of facilitating grip and the interest of increasing the efficiency or nested storage is resolved acceptably.

In one embodiment, an incremental increase in height of a stack of nested vessels, such as mug 200, body 100, or the like, associated with the addition of another vessel to the stack, referred to as ΔH, is substantially equal to or less than fifty percent (50%) of the height H of the vessel. Preferably, ΔH is substantially equal to or less than forty percent (40%) of the height H of the vessel. More preferably, ΔH is substantially equal to or less than thirty percent (30%) of the height H of the vessel. Yet more preferably, ΔH is substantially equal to or less than twenty percent (20%) of the height H of the vessel. Most preferably, ΔH is substantially equal to or less than ten percent (10%) of the height H of the vessel, such as approximately seven percent (7%) of the height H.

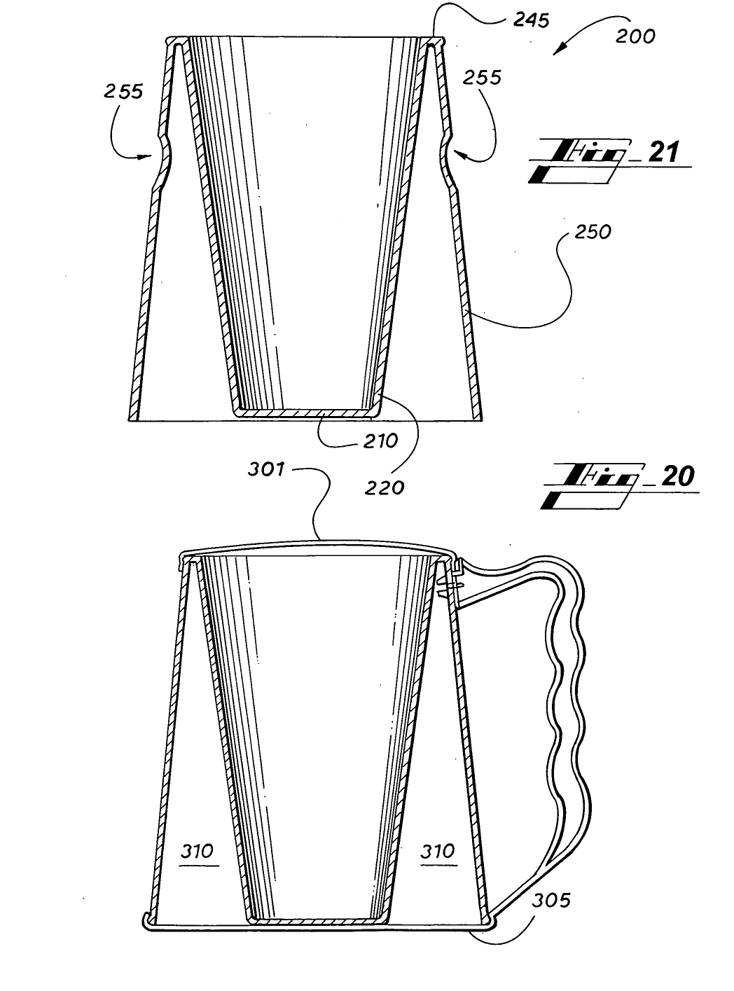

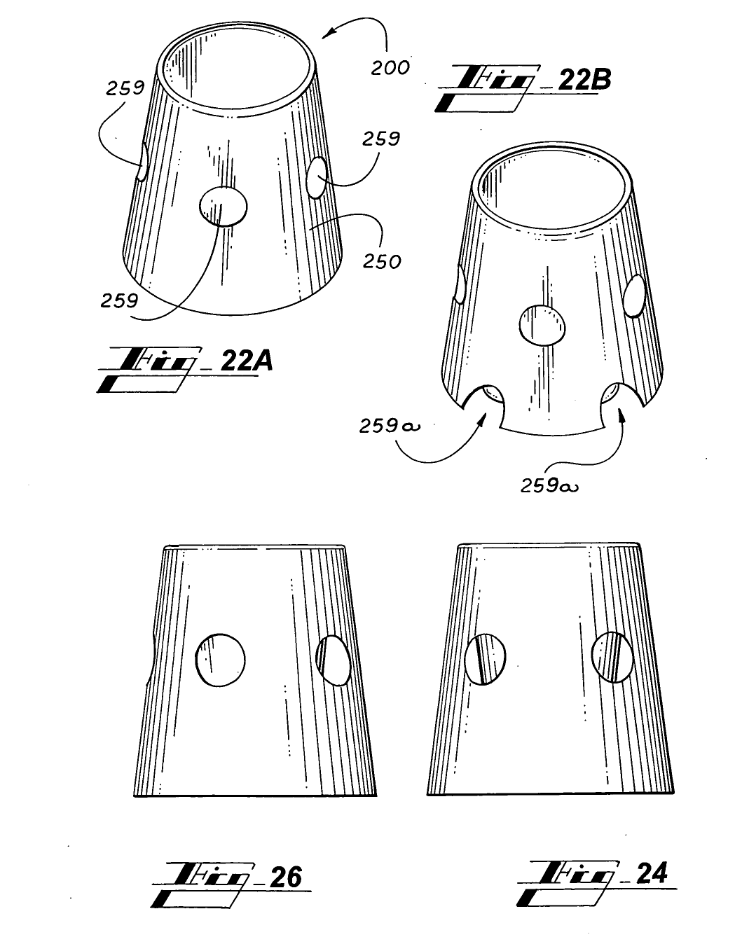

As a further alternative, and with reference to FIGS. 22-28, finger holes 259 may be formed in outer sidewall 250, whereby a user may pinch a portion of sidewall 250 proximate two holes 259 to grip mug 200. Holes 259 may be formed by removing a portion of the material of outer sidewall 250, by molding, or by bending a flap of material to allow finger access. In any configuration, such alternative or additional gripping structures preferably likewise provide a thermal insulation from liquid contents of mug 200 by spatial separation from inner sidewall 220. Thus, mug 200 having depression or channel 255 or having finger holes 259 is preferably suitable for use in hot beverage service. It is important to note that the inclusion of holes 259 do no affect an ability of mugs 200 to be stacked in a nested configuration. Therefore, holes 259 are preferred. As will be understood by those ordinarily skilled in the art, closed-loop holes 259 may be supplemented with or replaced by notches 259a disposed about a bottom edge of sidewall 250.

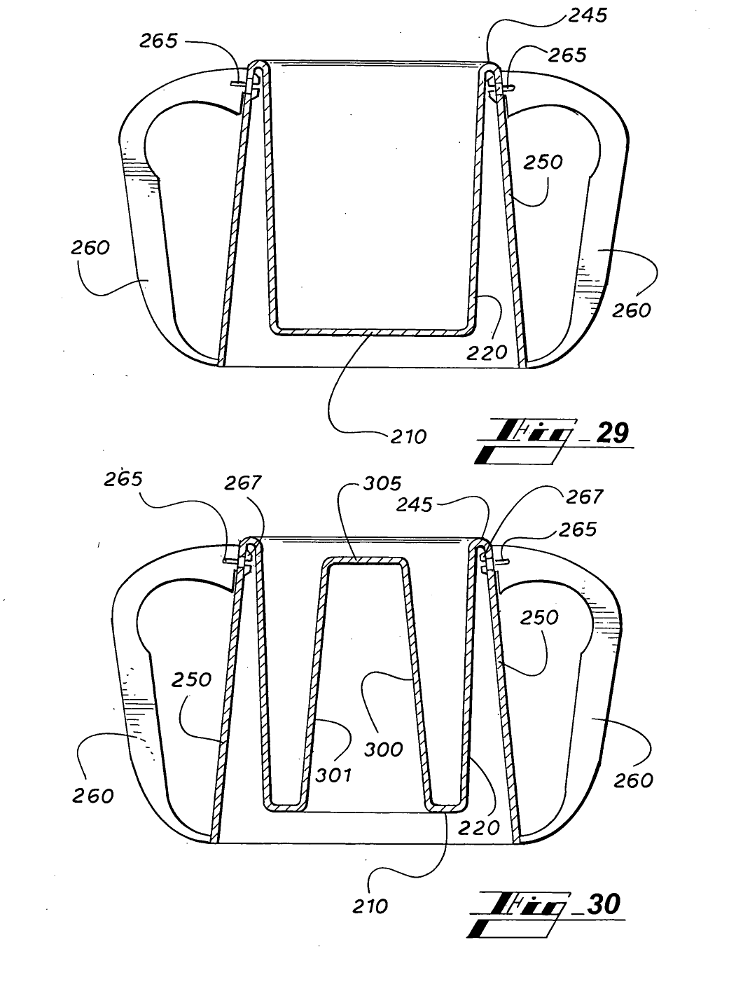

As yet another alternative configuration, and as illustrated in FIGS. 29 and 30, mug 200 may include two handles 260 disposed generally in opposition. Such configuration may be beneficial for children or the like for whom control of mug 200 with a single handle 260 or no handle 260 may be a problem. As such, mug 200 with two handles 260 may function as a training mug for children. Additionally, mug 200 may further comprise volume-reducing projection 300 comprising frusto-conical sidewall 301 and top 305. Volume-reducing projection 300 preferably functions to reduce a volume of liquid contained within mug 200 at a given level. For example, when liquid L is filled approximately to rim 245, as shown in FIG. 30, the inclusion of projection 300 preferably reduces a total volume of liquid L contained in partially enclosed space 230 by an amount substantially equal to an interior volume of projection 300. Thus, less liquid L may be spilled if a child drops mug 200 with projection 300 while still allowing the child to practice drinking from a full container, i.e. mug 200 where liquid L approximately reaches rim 245.

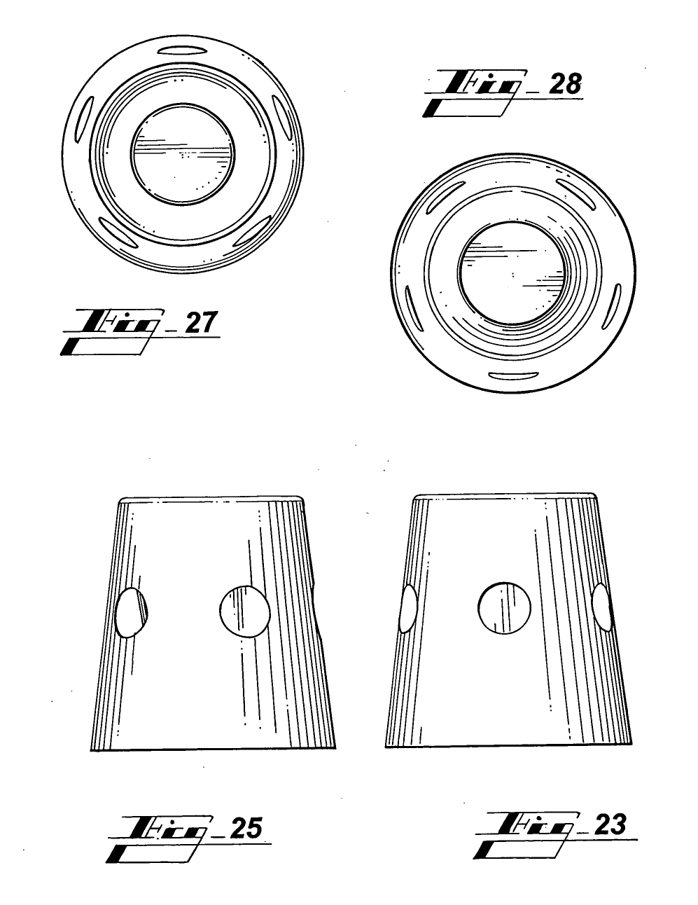

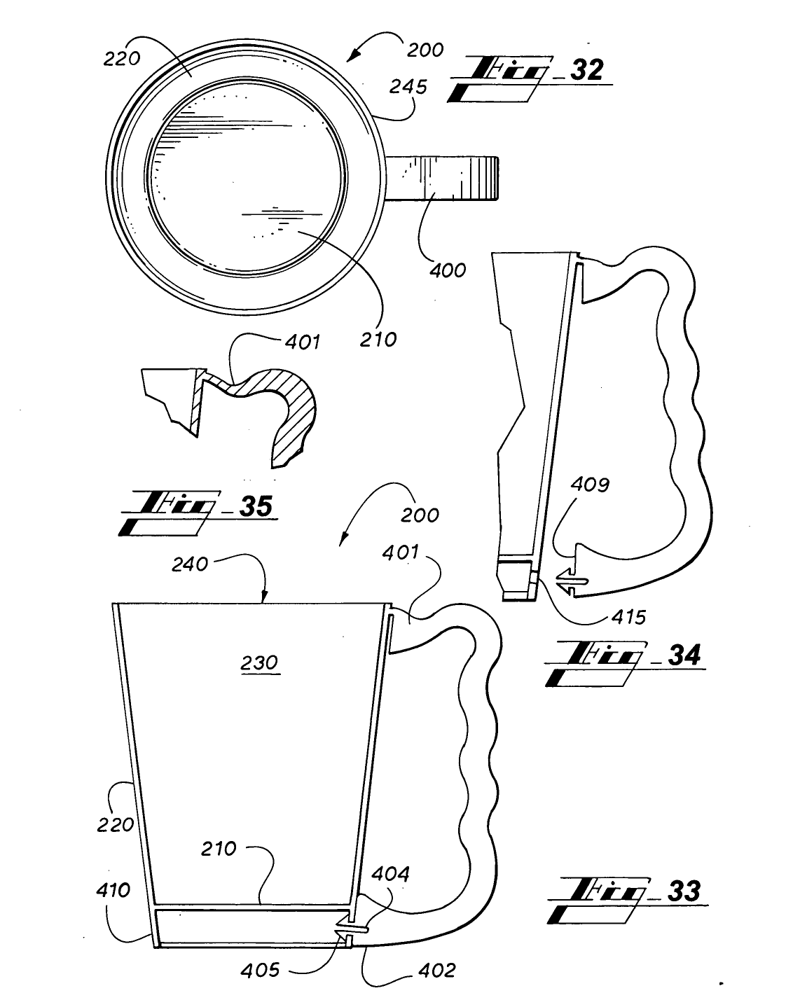

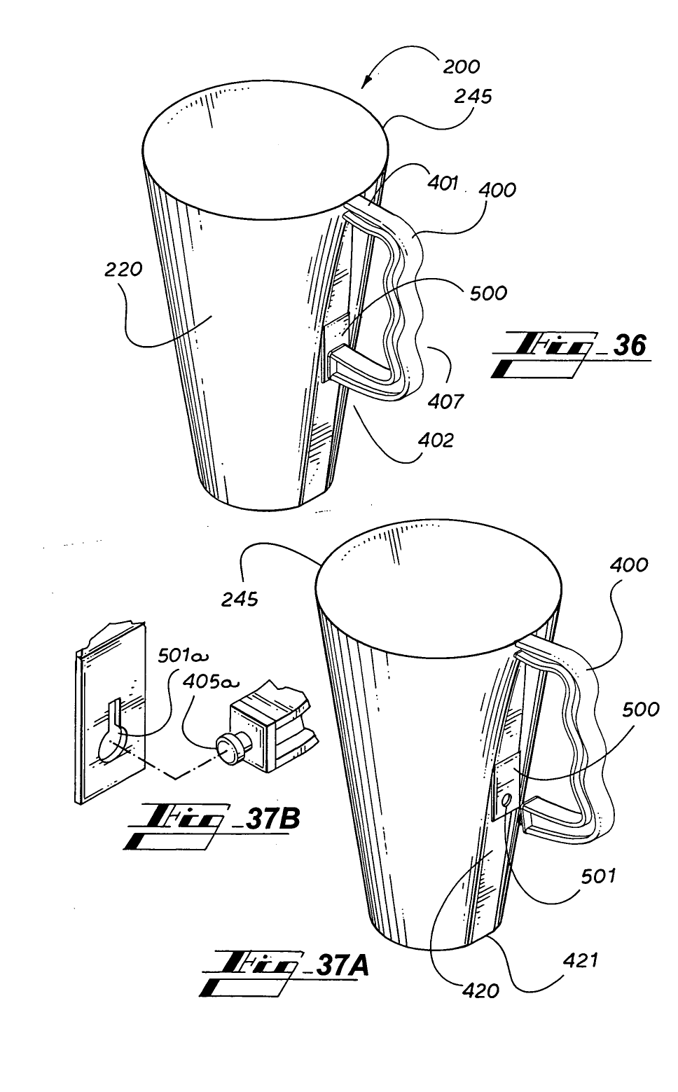

Now referring to FIGS. 31-35, if desired, such as in automobile applications where tipping is not a substantial concern due to cup holders or the like, outer frusto-conical sidewall 250 may be omitted and handle 400 may be included. First end 401 of handle 400 is preferable hingedly operable with sidewall 220 of mug 200 proximate rim 245 thereof and second end 402 of handle 400 is preferably engageable with portion 410 of sidewall 220 below bottom 210. For example, second end 402 may include prong 405 disposed on face 409 operable with opening 415 of portion 410 of sidewall 220. As will be understood by those ordinarily skilled in the art, however, second end 402 of handle 400 may be engageable with sidewall 220 via alternative means, such as adhesive, a clip, a strap, or the like. As with handle 260, handle 400 is preferably movable between a first storage position where second end 402 is spaced from sidewall 220 to allow nesting of mug 200 with others, as shown in FIG. 27, and a second use position where second end 402 is engaged with sidewall 220. Furthermore, such movement of second end 402 may be enabled by resiliency and/or flexibility of handle 400. Additionally, second end 402 may be compressible via notch 404, whereby prongs 405 may be compressed and removed from engagement with portion 410 of sidewall 220, and whereby mug 200 may be re-stacked in the nested configuration.

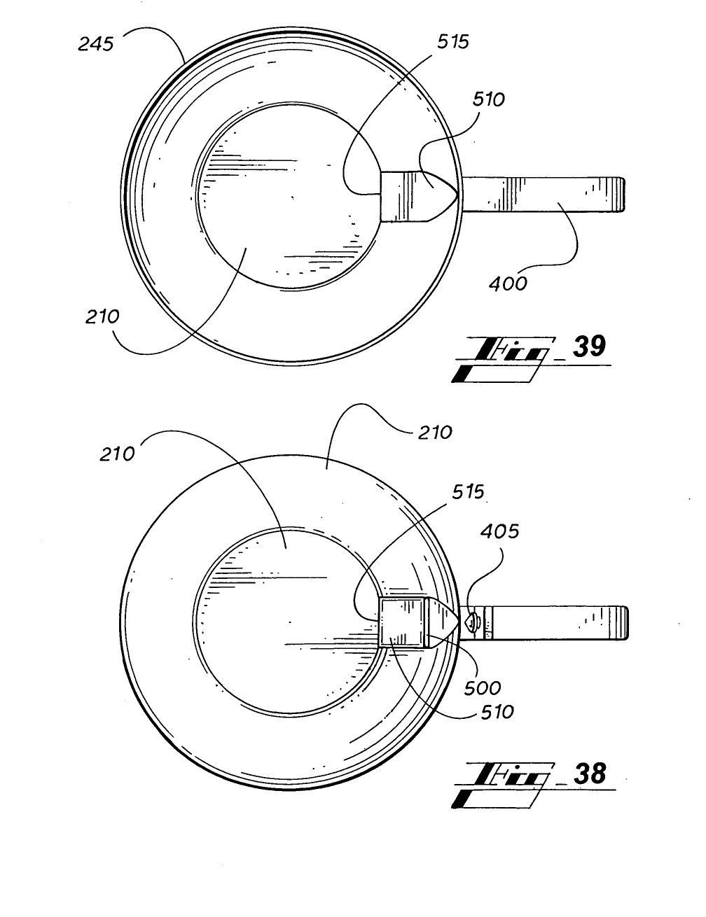

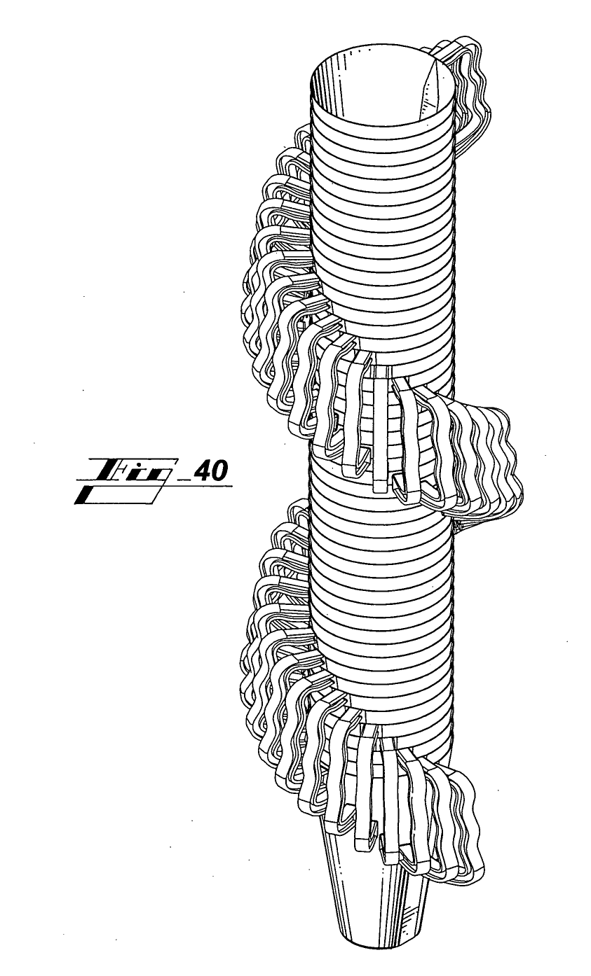

Now referring to FIGS. 36-39, second end 402 of handle 400 may alternatively engage a portion of sidewall 220 above bottom 210. Specifically, when such a partial-height handle is desired, second end 402 of handle 400 is preferably operable with tab 500 disposed on sidewall 220. Tab 500 may be integrally formed, such as during a molding process, or may be formed separately and subsequently attached to sidewall 220. Tab 500 preferably includes aperture 501 adapted to receive prong 405 of handle 400. Alternatively, however, a slot may be included in tab 500 to engage a flanged peg, or other projection, of handle 400. Tab 500 is preferably disposed on planar section 420 of sidewall 220. Planar section 420 is preferably associated with linear bottom edge portion 421 of sidewall 220. Rim 245, however, preferably does not include a linear edge portion, whereby a circular lid may securely engage rim 245 independent of rotational orientation. Accordingly, planar section 420 preferably tapers from linear bottom edge portion 421. As will be understood by those ordinarily skilled in the art, planar section 420 preferably creates a space between sidewall 220 of a first mug 200 and a second cup 200 disposed in a nested arrangement, wherein tab 500 may be disposed in the space to prevent unwanted interference of tab 500 with efficient nesting of mugs 200. Additionally, or alternatively, a flexibility and/or resiliency of tab 500 may avoid such unwanted interference and allow efficient nesting of mugs 200. It is also important to note that the shape of the taper of planar section 420 determines a maximum width of tab 500 at a given distance from bottom 210; i.e. if planar section 420 tapers at a constant rate, then the maximum width of tab 500 will be directly proportional to a distance from bottom 210 where planar section 420 has its greatest width to rim 245 where the width of planar section 420 is zero. Furthermore, a length of tab 500 determines a minimum rotational offset of a second mug 200 in a nested configuration. Accordingly, the minimum rotation offset of such a second nested mug 200 is related to the width of linear bottom edge portion 421 and the curvature of taper of planar section 420.

If desired, second end 402 of handle 400 may be releasably engaged with tab 500 (or with portion 410 of sidewall 220 or outer sidewall 250 depending on the design). Accordingly, prong 405 may be compressible to enable prong 405 to be removed from aperture 415. For example, prong 405 may be flexible or compressible itself, or slot 407 may be included in at least a portion of second end 402 of handle 400 to allow compression of prong 405. As an alternative, flanged projection 405a may be included on second end 402 of handle 400 and a slot, such as key-hole slot 501a may be included on tab 500 to enable releasable engagement of handle 400 with mug 200. As will be understood by those ordinarily skilled in the art, such releasable engagement means, i.e. the compressible prong and the flanged projection and slot arrangement, may be included on handle 260 to enable the handle to be releasable from mug 200.

While the foregoing disclosure may be understood without reference to relative and/or absolute dimensions, shapes, or the like, in a preferred embodiment, mug 200 includes a predetermined ratio of dimensions. Specifically, a width W of handle 260 where bottom 210 is round, or of tab 500 where linear bottom edge portion 421 is included, is preferably selected to approximately equal 1/N times the circumference of rim 245, where N is equal to an integer number. The integer number N is preferably selected from the group of integer numbers greater than M, where M is equal a height H of mug 200 divided by the incremental increase in height ΔH of a nested stack of mugs 200 associated with the addition a single mug 200 to the stack. Accordingly, even where N=M, a handle of a mug spaced by N mugs from another mug will be spaced therefrom by at least 1 complete handle length H, whereby interference therebetween may be avoided. When so configured, a plurality of mugs may be stacked for storage in a nested arrangement with each handle adjacent and to a first side of a preceding mug in the stack. Thus, the handles of the mugs spiral around a longitudinal axis of the stack, and the spiral may complete more than one 360° circuit of the longitudinal axis, as shown in FIG. 40.

Having thus described exemplary embodiments of the present invention, it should be noted by those skilled in the art that the within disclosures are exemplary only and that various other alternatives, adaptations, modifications, and/or combinations may be made within the scope and spirit thereof. Particularly, it should be noted that teachings or other discussion made with reference to one embodiment, including discussions of alternative structures, uses, functions, or the like, are intended to likewise apply to other embodiments, whether specifically illustrated and/or described or not, and such teachings are not necessarily intended to apply solely to the embodiment(s) in reference to which they are made. Accordingly, the present invention is not limited to the specific embodiments as illustrated herein, but is only limited by the following claims.

What is claimed is at least:

1. A nesting drinking vessel for containing a beverage comprising:
a body having a configuration adapted to nest with at least one other drinking vessel substantially having the configuration; and
at least one structure for gripping,
wherein said at least one structure for gripping is thermally-insulated from the beverage contained in said drinking vessel.

2. The nesting drinking vessel of claim 1, wherein said body is adapted increase a height of a stack of nested vessels by less than approximately ten percent when said vessel is added to the stack.

3. The nesting drinking vessel of claim 1, wherein said body is movable from a first storage configuration to a second use configuration.

4. The nesting drinking vessel of claim 3, wherein said body is adapted to nest with at least one other vessel in said first storage configuration, and where said body is not adapted to nest with at least one other vessel in said second use configuration.

5. The nesting drinking vessel of claim 3, wherein said body is movable via an expandable sidewall.

6. The nesting drinking vessel of claim 3, wherein said body is movable via a plurality of folds.

7. The nesting drinking vessel of claim 1, wherein said body further comprises a base that has a cross-sectional dimension that is greater than a cross-sectional dimension of a top of said body.

8. The nesting drinking vessel of claim 1, wherein said at least one structure for gripping comprises a handle.

9. The nesting drinking vessel of claim 8, wherein said handle comprises at least one aperture formed through an exterior sidewall of said body.

10. The nested drinking vessel of claim 9, wherein said at least one aperture is selected from the group consisting of a closed-loop aperture and a notch.

11. The nesting drinking vessel of claim 8, wherein said handle comprises a first end that is movable between a first storage position and a second use position, wherein said first end is not engaged with said body in the first storage position and wherein said first end is engaged with said body in the second use position.

12. The nesting drinking vessel of claim 11, wherein said handle is selected from the group consisting of a hinged handle and a resilient handle.

13. The nesting drinking vessel of claim 8, wherein said handle comprises a first end having means for releasably engaging said body.

14. The nesting drinking vessel of claim 13, wherein said means for releasably engaging said body comprises a compressible prong adapted to engage an aperture of said body.

15. The nesting drinking vessel of claim 13, wherein said means for releasably engaging said body comprises a flanged projection engageable with a slot of said body.

16. The nesting drinking vessel of claim 13, wherein said means for releasably engaging said body comprises a tab having a slot formed therein.

17. The nesting drinking vessel of claim 13, wherein said means for releasably engaging said body comprises a slotted prong.

18. The nesting drinking vessel of claim 8, wherein said handle comprises a folded portion of a sidewall of said body.

19. The nesting drinking vessel of claim 18, wherein said handle is formed during a conversion of said body from a first storage configuration to a second use configuration, and wherein a base of said body has a cross-sectional dimension that is greater than a cross-sectional dimension of a top of said body in said second use configuration.

20. A nesting drinking vessel of claim 1, wherein said body comprises a bottom and sidewall defining a partially enclosed interior space for containing the beverage, wherein a width of said interior space increases in a first direction from said bottom, and a base having a width greater than a width of an open top of said interior space, wherein said vessel comprises a space between said base and said sidewall.

21. The nesting drinking vessel of claim 1, wherein said at least structure for gripping comprises at least one ridge formed on a sidewall of said body.

22. The nesting vessel of claim 1, wherein said at least one structure for gripping comprises at least one indentation formed in a sidewall of said body.

23. The nesting vessel of claim 1, further comprising a gutter for collecting liquid therein.

24. The nesting vessel of claim 8, further comprising a tab disposed on said body for receiving a first end of said handle.

25. The nesting vessel of claim 24, wherein said tab is disposed on a generally planar portion of said body.

26. The nesting vessel of claim 25, wherein said generally planar portion of said body is associated with a generally linear section of a base of said body, and an upper rim of said body is round.

27. A nesting drinking vessel for containing a beverage comprising:
a sidewall and a bottom defining a space for containing the beverage;
wherein said vessel is convertible from a first storage configuration to a second use configuration and wherein said vessel is stackable in a nested arrangement in said first storage configuration.

28. The vessel of claim 27, wherein said bottom comprises a cross-sectional dimension that is greater than a cross-sectional dimension of an open top of said vessel in said second use configuration.

29. The vessel of claim 28, wherein said vessel is convertible from said first storage configuration to said second use configuration via folding a plurality of portions of said sidewall of said vessel.

30. The vessel of claim 28, wherein said cross-sectional dimension of said open top is greater than said cross-sectional dimension of said bottom in said first storage configuration.

31. The vessel of claim 28, wherein said cross-sectional dimension of said bottom in said first storage configuration is substantially equal to said cross-sectional dimension of said bottom in said second use configuration.

32. The vessel of claim 27, wherein at least a portion of said sidewall comprises an adjustable cross-sectional dimension.

33. The vessel of claim 27, further comprising a handle, and wherein said vessel is convertible from said first storage configuration to said second use configuration via engagement of a first portion of said handle with said vessel.

34. The vessel of claim 27, further comprising a plurality of rim sections disposed on respective portions of said sidewall.

35. The vessel of claim 34, wherein each of said rim sections is adapted to engage at least one of another one of said plurality of rim sections and a portion of said sidewall.

36. The vessel of claim 27, further comprising at least one ridge formed on said sidewall.

37. The vessel of claim 27, further comprising at least one indentation formed in said sidewall.

38. The vessel of claim 33, wherein said handle comprises at least one of a prong and a flanged projection.

39. The vessel of claim 33, further comprising at least one of an aperture and a slot operable with said first portion of said handle.

40. The vessel of claim 33, wherein said handle comprises at least one of a hinged second portion and a resilient material.

41. The vessel of claim 33, wherein said first portion of said handle is removably engageable with said vessel.

42. The vessel of claim 41, wherein said first portion of said handle comprises at least one of a compressible prong and a flanged projection.

43. The vessel of claim 33, wherein said first portion of said handle comprises a slot, wherein said first end is compressible via compression of said slot.

44. The vessel of claim 27, wherein addition of said vessel in said first storage configuration to a nested stack of a plurality of vessels in the first storage configuration increases a height of the stack by an amount less than approximately ten percent of a height of said vessel.
